(19) United States
(12) Patent Application Publication
(10) Pub. No.: US 2010/0225156 A1
(43) Pub. Date: Sep. 9, 2010

(54) Wheel having inner bead-lock

(76) Inventor: Ray W. Lipper, Santa Fe Springs, CA (US)

Correspondence Address: CHRISTIE, PARKER & HALE, LLP, PO BOX 7068, PASADENA, CA, 91109-7068, US

(21) Appl. No.: 11/639,496

(22) Filed: Dec. 15, 2006

(51) Int. Cl. B60B 25/04

(52) U.S. Cl. 301/29.2

(57) ABSTRACT

The present invention provides a vehicle wheel system having an interior wheel half, an exterior wheel half and an integral centering element which are concentrically aligned with each other, where the centering element has a bead lock for securing a bead of a tire to enable vehicle operation during a flat tire. For a heavier, military vehicle wheel system, a varied centering element is used in conjunction with segmented inner tire system to further strengthen the deflated tire.

### RELATED APPLICATION INFORMATION

The present application is related to, and claims priority from, a U.S. design application, Ser. No. 29/261,652 filed on Jun. 15, 2006 of the same inventor, Ray W. Lipper entitled Integral Centering Element for a Wheel.

### BACKGROUND OF THE INVENTION

1. Field of the Invention

The present invention relates to vehicle wheels, and more particularly to run flat tires which can be used to operate a vehicle when there is a flat or deflated tire.

2. General Background and State of the Art

Lightweight Application—Light Trucks and S.U.V.'s

There are two main problems that exist in this art. One is that the weight of a single tire and wheel combined for the vehicles at issue here could weigh in excess of 100 pounds. Therefore, depending on the strength and/or gender of the individual confronted with the possible task of dismounting a flat tire and wheel from the vehicle and remounting the spare tire, it is very difficult if not impossible. It is therefore a significant advantage for a vehicle to be able to run on a deflated tire at least for a certain amount of distance to deliver a passenger to a safe place for a repair or to change the vehicle.

The second problem also relates to safety. When a tire blows out, it can be from a sudden impact or from a faulty tire. Regardless of how a tire blows out, however, it can cause the deflated tire to transverse freely or uncontrollably within the wheel rim and can rapidly result in a rollover of the vehicle at normal speeds.

The conventional pneumatic tire and wheel combination for automobiles and light trucks are based on a configuration of the rim which includes a tire mounting well or drop smaller in diameter than the actual outer confines of the rim. The well lies in close proximity to the rim edge to facilitate easy mounting of the tire. When one of the tire beads is placed within the drop area, the geometry of the tire with the assistance of tools or equipment will allow the balance of the tire to be mounted within the wheel and rim section, thereby allowing its inflation. Aside from that purpose, the wheel well has no other practical use. However, in the event of a flat or a blow out, the tire would normally drop back into the wheel well which makes the vehicle inoperative.

Prior solutions to the above problems are now described. Run-flat tires have been manufactured by various parties such as Goodyear which introduced an asymmetrical design to lock the bead in. This was done around 1983. Further, one solution was to introduce a wheel where its solid inner wheel inserts within the tire. A manufacturer introduced “PAV” around 1997. PAV is translated as “Vertical Anchorage Tire.” The acronym PAV was later changed to PAX around 1998. The key elements of the PAX system are special wheels with unique tire bead locks and a solid insert that can fully support its shape of the vehicles weight and let it continue rolling even without any tire pressure.

Furthermore, in 2002, Bridgestone Corporation and Continental Tire developed a run flat tire. It was later abandoned since the equipment to mount and dismount the tires was specialized. It should be noted that in each of the above developments, the concentration was directed at passenger or sports car type vehicles with low aspect ratio tires (tread width divided by sidewall height.)

All of the above concepts have seen considerable research and development programs by major tire manufacturers, which suggest that it is an important issue, but to date it has not been met with much success. Additionally, it suggests there is little perfected run-flat technology for large tires (light trucks and S.U.V's) that pose different geometry and load ratings to that of passenger cars.

In terms of bead-lock wheel technology, all conventional and automotive tires and rims correspond in the contour of the bead, thereby providing an airtight (wheel to and from tire) combination. The most popular bead-lock wheel/rim concept requires that the rim be altered on the outboard portion to provide for a coaxial ring with a series of threaded holes near the inner circumference. This ring is generally welded to the altered rim.

The tire can be mounted to the wheel by hand or with mounting equipment. However, the outboard portion of the tire must be positioned to lie on top of the attached ring and aligned outside the threaded holes. The unattached ring can now be fastened into position with bolts clamping and compressing the tire beads to a non-leaking state, and then inflated. Used conversely to the tires' original design and concept, this solution may be used for short durations which are required for racing purposes prior to chronic air leaking. However, it is not satisfactory for use with light trucks and S.U.V.'s.

The present invention is an improvement on the existing bead-lock technology. It is also related to the technology of, and improves upon, a prior modular vehicle wheel as shown in U.S. Pat. No. 4,989,657 by the same inventor, issued on Feb. 5, 1991, entitled “Modular Vehicle Wheel.” In that patent, a two-piece modular automotive wheel is shown including a rear section having a relatively thick center portion and a thinner rim portion. The rear section is produced by a spin forging process to achieve the desired thickness at various locations. A registration surface is machined in the center portion. A front rim section is secured to the rear section at the registration surface. A locking ring, which may also be spun forged, may be secured to the front rim section to lock the bead of the tire. The content of U.S. Pat. No. 4,989,657 is hereby incorporated by reference.

Military Tactical Vehicle Run Flat Wheels

Another area of improvement in run flat wheels that the present invention is concerned with is for military tactical vehicle wheels and the like. There are mainly two problems that this area. One is that conventionally, mounting and dismounting and/or inserting and removing a deflated tire from the wheel required skills, specialized equipment and an inordinate amount of time. This is principally due to the obstruction of the existing solid rubber inner (run flat) tire ring which is 30% larger in diameter than the diameter of the hole in which it must fit. It is still possible to fit the run flat tire with the use of specialized equipment and technicians. However, the fact that it requires the specialized equipment and certain skills contributes to the difficulty that arises when a flat or deflated tire occurs.

Specifically, the solid rubber inner run flat tire ring measures 661.37 mm or 26.0 inches in diameter with a 4.0 inch thick cross section. From a strictly geometrical and physical stand point, it is extremely difficult to insert a 26.0 inch diameter object into a 17.0 inch diameter hole, and it is equally difficult to remove the object intact. However, given sufficient time, manpower and the specialized equipment, it is possible to achieve the task. One way is to compress the existing solid rubber inner tire ring under several tons of static pressure to a contour that is befitting 17.0-inch diameter hole. However, as mentioned above, the fact that the task requires specialized equipment and skills contributes to the difficulty encountered by a flat tire in the first place.

The second problem is related to time, i.e., the time required to change a deflated, run flat tire under the existing solid rubber ring concept. Currently, the required time to disassemble and re-assemble a deflated or disabled tire is about five hours using existing method.

It is therefore an object of the present invention to provide an improved wheel system which allows for a safer operation of a vehicle for a longer duration for light trucks and S.U.V.'s on one hand, and military vehicle on the other the like in the event of a flat or blown out tire.

It is another object of this invention to provide a wheel system which, in the event of a flat or blow out, prevents contortion of the tire in the wheel well.

It is yet another object of this invention to provide a wheel system which can be mounted and dismounted without specialized equipment and with less time.

It is yet another object of this invention to provide a wheel system which employs a bead lock system on a coaxial integral centering element.

These and other objects and advantage of the present invention will become readily apparent from the detailed description taken in conjunction with the accompanying drawings.

### INVENTION SUMMARY

The wheel configuration according to the present invention is a means to maintain driver or operator control with a deflated tire at slow speeds while minimizing the possibility of a rollover of the vehicle in the event of low tire pressure or a tire blow out on normal light trucks or S.U.V.'s at low speeds. The present invention provides a system which retains or locks the tire bead against the rim with an internal bead lock that disallows any tire movement that can cause abrupt changes in the vehicle direction.

Specifically, the wheel system employs three main parts, an exterior wheel half, an interior wheel half and a coaxial integral centering element. The coaxial integral centering element is provided with a centering element rim, an inner clamping bead lock, and a collar for centering and aligning with the two wheel halves. The inner clamping bead lock is provided to fix a tire by one of the rims of the tire. Another embodiment of the present invention employs segmented inner tire system in addition to a variation of the centering element above.

### BRIEF DESCRIPTION OF THE DRAWINGS

The invention will now be described with reference to the accompanying drawings.

FIG. 1 shows an exploded view of a wheel according to a present invention with a tire;

FIG. 2 shows a cross-sectional view of the wheel according to the present invention with an inflated tire;

FIG. 3 shows a cross-sectional view of the wheel according to the present invention with a deflated tire;

FIG. 4 shows a cross-sectional view of the assembled wheel for a military vehicle use with inner tire sections;

FIG. 5a shows a cross-sectional view of the integral centering element for a military vehicle;

FIG. 5b shows a cross-sectional view of the inner tire sections;

FIG. 6 shows a cross-sectional view of the assembled wheel system for the military vehicle tire, including the inner tire sections and a partial cross-sectional view of the tire in two states;

FIG. 7a shows a plan view of an O-ring;

FIG. 7b shows a cross-sectional view of the O-ring of FIG. 7a;

FIG. 7c shows another cross-sectional view of the O-ring of FIG. 7a;

FIG. 8 shows a plan view of the inner tire section;

FIG. 9 shows a cross-sectional view of the inner tire section of FIG. 8; and

FIG. 10 shows a plan view of the inner tire for the military vehicle tire.

### DETAILED DESCRIPTION OF THE PREFERRED EMBODIMENTS

### Lightweight Application—Light Trucks and S.U.V's

The following description is of the best presently contemplated mode of carrying out the invention. This description is made for the purpose of illustrating the general principles of the invention and is not to be taken in limited sense. The scope of the invention is best determined by reference to the appended claims.

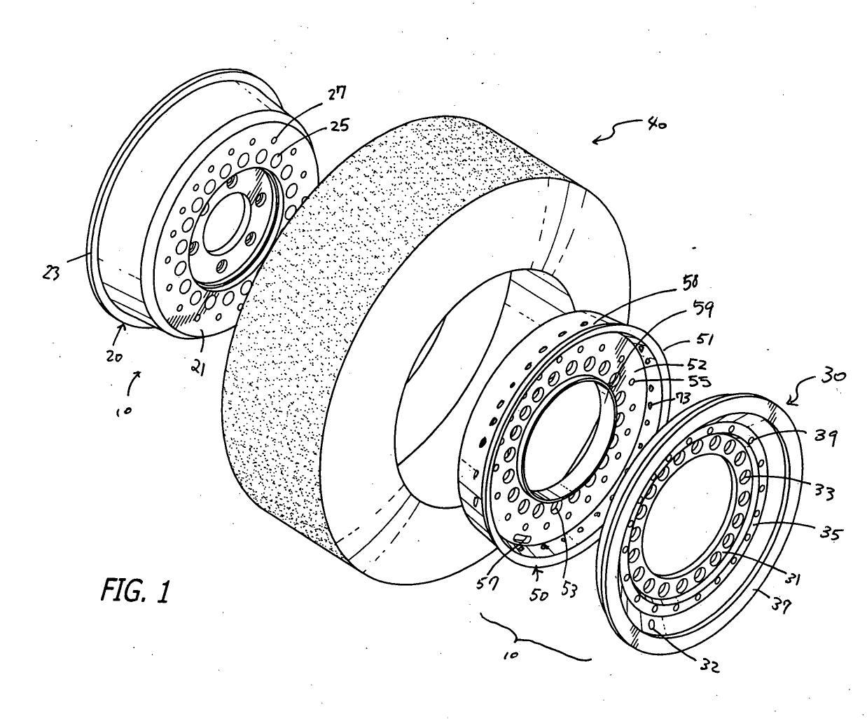

Referring now to the drawings, there is shown in FIG. 1 in an exploded view, a wheel generally designated 10, constructed in accordance with the teachings of the present invention. Wheel 10 has three main portions. The outer two portions are both cup-shaped wheel halves 20 and 30. The exterior wheel half 20 is employed on the exterior side of a tire 40 and the interior wheel half 30 is employed on the interior side thereof. A third element of the wheel is a coaxial integral centering element 50.

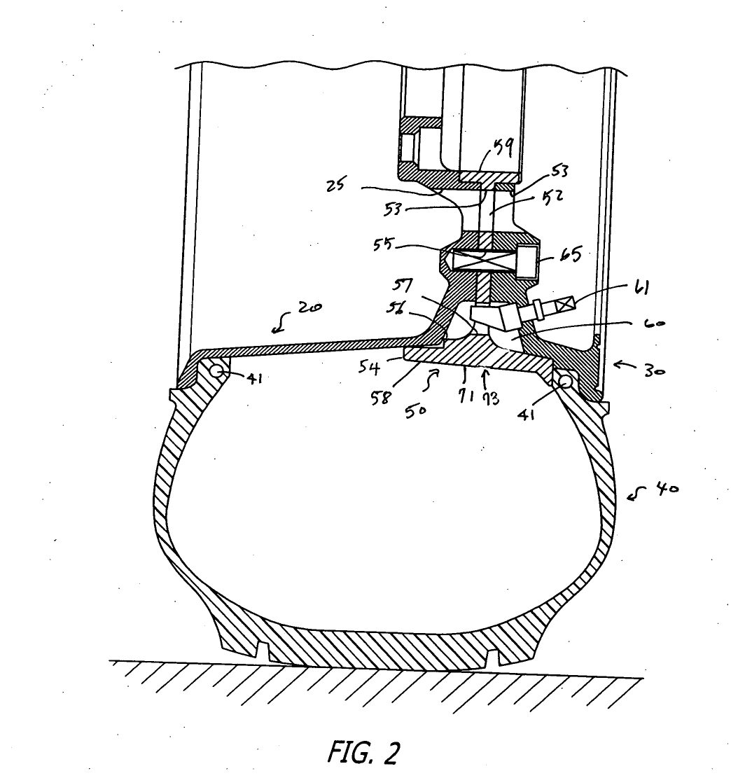

FIG. 2 shows a partial cross-sectional view of the assembled wheel 10 with a tire 40 mounted and inflated. The exterior and interior wheel halves 20 and 30 are shown sandwiching the coaxial integral centering element 50 therebetween.

In FIG. 1, the wheel halves 20 and 30 have center sections 21 and 31, respectively, and integral rim sections 22 and 37, respectively. Thus, each of the wheel halves 20 and 30 is made in one piece, preferably from a material such as aluminum. Furthermore, because of the cup-shaped appearance, each of the wheel halves 20 and 30 may be forged in accordance with known manufacturing procedures.

The exterior wheel half 20 has the rim section 23 and the center portion 21. In the center portion 21, a circular row of multiple lightening holes 25 are provided. These lightening holes 25 lessen the amount of material carried by the wheel 10 and serve to lighten the weight thereof. Another circular row of bolt holes 27 are provided to accommodate bolts 65 (FIG. 2) to hold the exterior wheel half 20, the integral centering element 50 and the interior wheel half 30 together and are provided radially outside of the row of lightening holes 25. The rows of bolt holes 27 and the lightening holes 25 are provided concentrically.

Similarly, the interior wheel half 30 has the rim section 37 and the center portion 31. In the center portion 31, a circular row of multiple lightening holes 33 are defined to lighten the weight. Radially outside of these holes 33, another circular row of holes, bolt holes 39 are defined to accommodate the above-mentioned bolts 65 (FIG. 2). In addition, an air sensor slot 32, is provided radially adjacent to an intermediate portion 35 and an integral rim section 37 of the interior wheel half 30. This air sensor slot 32 is provided to accommodate an air sensor 61 shown in FIG. 2.

The integral centering element 50 as seen in FIGS. 1-3 has a collar 59 in the center thereof The collar 59 centers different portions of the wheel 50, namely the exterior and interior wheel halves 20 and 30. As shown in FIG. 2, a disc portion 52 connects the collar 59 in the center and a centering element rim 58 at the outer rim. The centering element rim 58 is substantially flat on the exterior side but has an inner clamping bead lock 51 toward the interior side of the wheel. The bead lock 51 is a part of the integral centering element 50 and forms a ridge or rim which protrudes from a centering element rim surface 71. The inner clamping bead lock 51 clamps an interior end of a tire 40 between itself and a rim of the interior wheel half 30. An end 54 is situated on the other side of the centering element rim 58 opposite the inner clamping bead lock 51. Steel cables 41 are provided in the tire 40 as shown (cross sections shown).

The provision of the inner clamping bead lock 51 is significant because it is the result of improving by physically extending a portion of a modular vehicle wheel, such as the modular vehicle wheel of the U.S. Pat. No. 4,989,657 which was mentioned above, to what has been considered up till now unobtainable inner reaches of the tire and its bead seat location, which can permanently lock the tire bead in place against the rim upon assembling the tire and wheel. Further, the integral centering element 50 becomes a stationary fixed part of the modular wheel that cannot be introduced to conventional wheels or rims by other permanent means and therefore is not an add-on feature.

Another feature of the centering element 50 is the shelf, i.e., the centering element rim 58, over the normal tire mounting well 60. The centering element rim 58 allows the transition of the deflated inboard tire bead to find its new center without interruption. It provides support for the tire bead and the ultimate contact of the tire's counter part that is in direct contact with the road.

The integral centering element surface 71 is tilted at an angle of approximately 4 degrees. A slight variation to this tile angle is, however, permitted to the extent the integral centering element 50 still functions for the purpose it is intended. Further provided on the other side of the centering element rim surface 71 toward the integral centering element end 54 is a step 56. The step 56 serves to fix the integral centering element 50 with respect to the tire mounting well 60 by wedging the integral centering element rim 58 against a shoulder of the exterior wheel half 20 as shown in FIG. 2. It functions as a reinforcement of the integral center element 50 against the inboard portion of the centering element rim 58.

In the centering element rim 58 of the centering element 50, a series of air intake holes 73 are equally spaced and drilled on the outer circumference thereof. In this embodiment, twenty air intake holes are provided. These apertures provide passages for air to inflate the tire.

All three modular sections of the wheel are forged aluminum (series 6061), then heat-treated and aged to its highest tensile strength. Using the choice of Forged Aluminum material proved superior to that of cast aluminum or steel, thereby resulting in equal or better strength characteristics, and providing less weight and rotating mass.

Manufacturing process for all three components of the wheel is similar and is described herein. First, the aluminum material is cut from 8-inch or 9-inch diameter×20-foot length into cylinder lengths with a predetermined volume. The cylinder is then heater to a temperature over 900° F. The heater cylinder is placed within a forge die that is exclusively designed and constructed to manufacture this forged component of the wheel to a predetermined shape. The forge die coupled with a 4000-ton forge press then compresses the aluminum cylinder, converting its material properties and shape. Subsequent to the above conversion, there are other machine processes requiring punch presses and C.N.C. spinning equipment that further convert each component. The components are then heat treated and aged to a predetermined hardness. Then, the components are staged for their finish machine process. Subsequent processes are cosmetic as well as assembly processes.

In FIG. 1, the coaxial integral centering element 50 has a circular row of lightening holes 53, an air sensor slot 57, to accommodate an air sensor 61 for sensing the tire air pressure, and a circular row of bolt holes 55. The bolt holes 55 are positioned to coincide with the bolt holes 27 of the exterior wheel half 20 and the bolt holes 39 of the interior wheel half 30. Similarly, a circular row of lightening holes 53 are provided to coincide with the lightening holes 25 and 33 of the exterior wheel half 20 and the interior wheel half 30, respectively, when the three parts 20, 30 and 50 of the wheel 10 are assembled.

The centering element 50 aligns the two wheels halves 20 and 30 without any shearing movement of the mating components. Having been bolted together with a series of fasteners or bolts 65, the strength of these three components is such that the wheel reacts and operates as a solid state object. In addition, the provision of the collar 59 of the centering element 50 absorbs any adverse impact of the fasteners and lug bolts that under normal circumstance may rely on them to maintain stability.

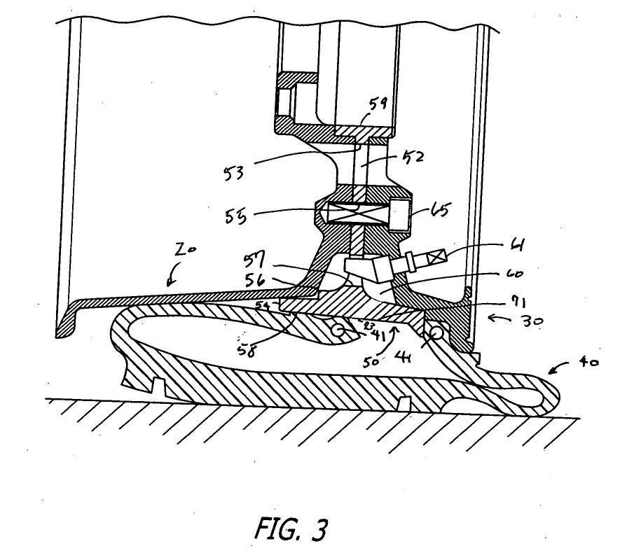

FIG. 3 shows the wheel 10 of FIG. 2 with the tire 40 in a deflated condition. In such a state, if the automobile is continued to be driven, the deflated tire can become twisted and form an “8” shape without the integral centering element 50. With the conventional wheel without the integral centering element 50 of the present invention, the twisted deflated tire can then end up in a tire mounting well 60. In such a condition, the automobile cannot be driven to a safe location. In contrast, having the integral centering element 50 enables the driver to continue driving for a longer distance than he would otherwise.

### Military Tactical Run-Flat Wheel

FIG. 4 shows a cross-sectional view of an assembled wheel 10a for use with a military vehicle. The elements of similar parts will bear the same number as those used for the wheel for the light weight trucks and S.U.V.'s of FIGS. 1-3 but have a's to distinguish them for use with military vehicle. Unless otherwise noted, the parts will be generally equivalent in configuration. An interior wheel half 30a and exterior wheel half 20a are centered by an integral centering element 90 for the military vehicle. A series of bolts 11 a fix the parts of the wheel, i.e., the exterior wheel half 20a through equal number of bolt holes 27a in a centering portion 21a, the centering element 90 and the interior wheel half 30a, through its bolt holes 39a in an intermediate portion 35a. Lightening holes 25a and 33a are provided to lighten the weight of the wheel. The lightening holes 25a are positioned in a centering portion 21a of the exterior wheel half 20a. On the exterior wheel half 20a, an integral rim section 23a defines the lip portion of the outer circumference. A peripheral edge of the interior wheel half 30a is defined as an integral rim section 37a. An air sensor slot 32a is provided on the interior wheel half 30a.

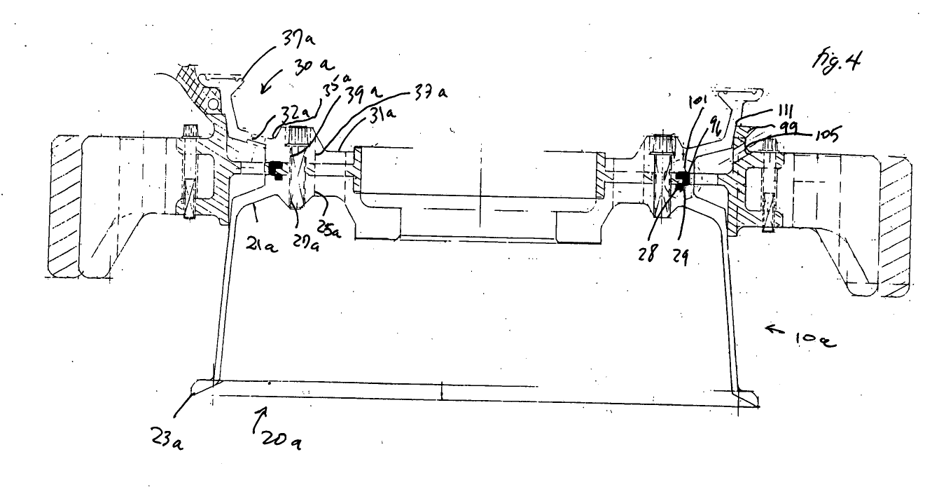

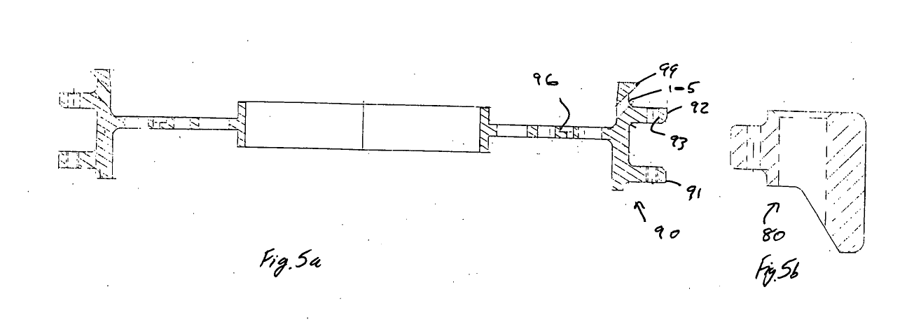

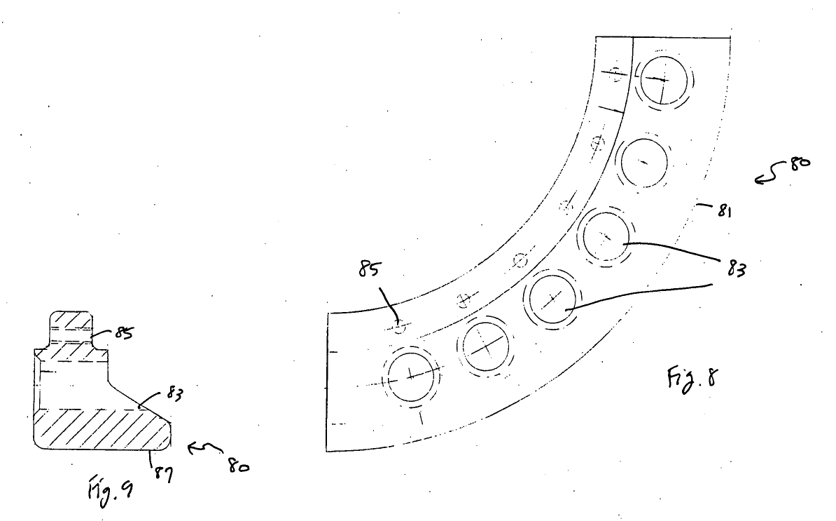

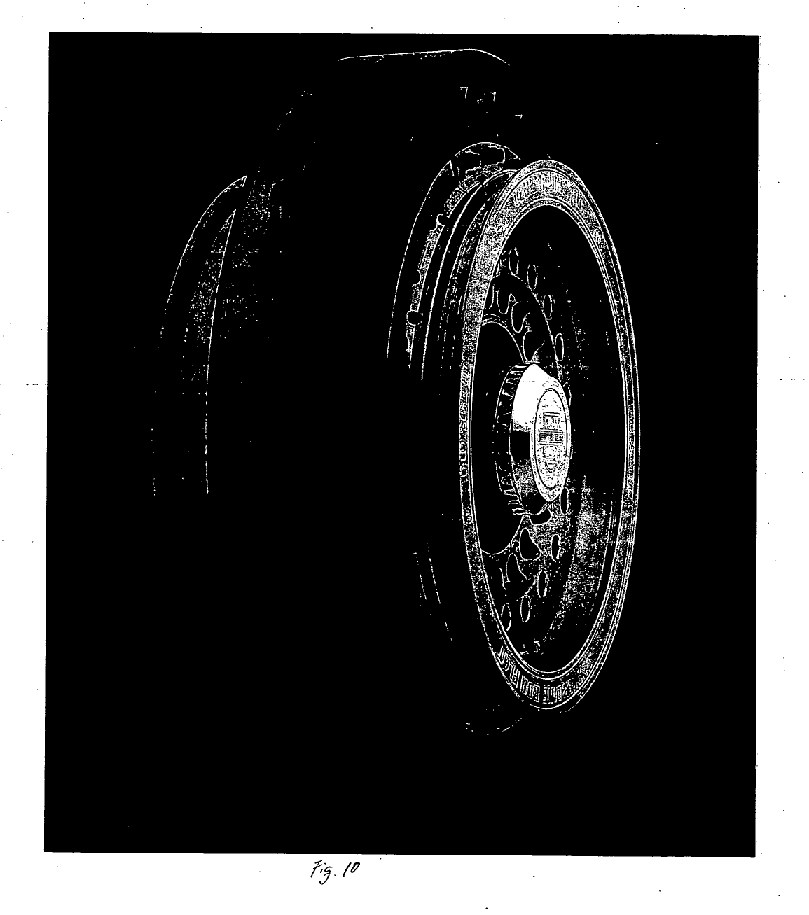

A cross-sectional figure of the military vehicle centering element 90 is provided in FIG. 5a which shows it independently of the wheel halves 20a and 30a. The centering element 90 is set next to a military tactical run flat inner tire, or inner tire 80. The outer circumference of the centering element 90 has two prominent flanges, a first flange 91 and a second flange 92, which protrude away from the center of the centering element 90. On the side of the second flange 92, a series of air passages 105 are provided in a similar fashion as in the assembled wheel for light weight application. A bead lock 99 is provided near the second flange 92. The inner tire 80, specifically one of four sections 81 (FIG. 8) of the inner tire 80, is designed to lodge between the two flanges 91 and 92 of the centering element 90. The inner tire section 81 is then fixed with a series of attachment screws 94 (FIG. 6) which fit through attachment screw holes 93 provided in the first and second flanges 91 and 92. FIG. 8 shows one of the four inner tire sections 81, with a series of small apertures, attachment screw holes 85, and another series of larger apertures for lightening 83. The small attachment screw holes line up with the attachment screw holes 93 of the centering element 90 to accommodate the attachment screws 94.

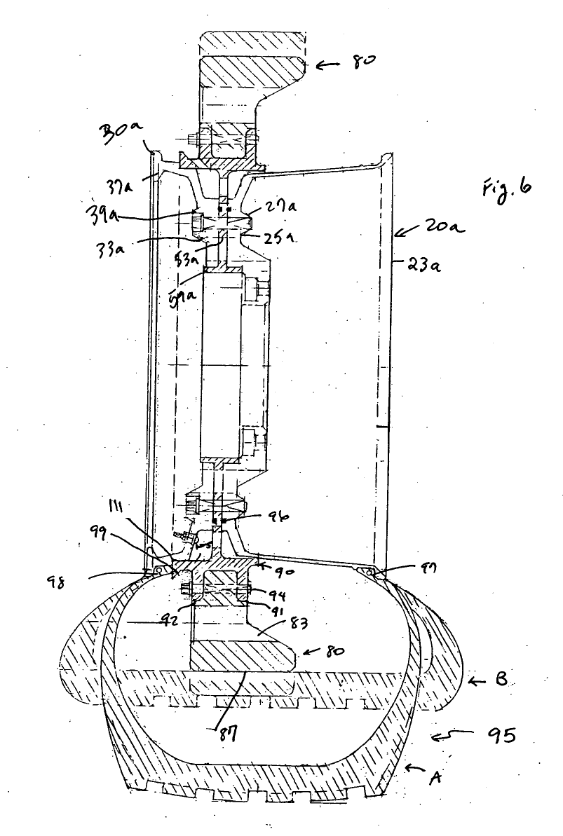

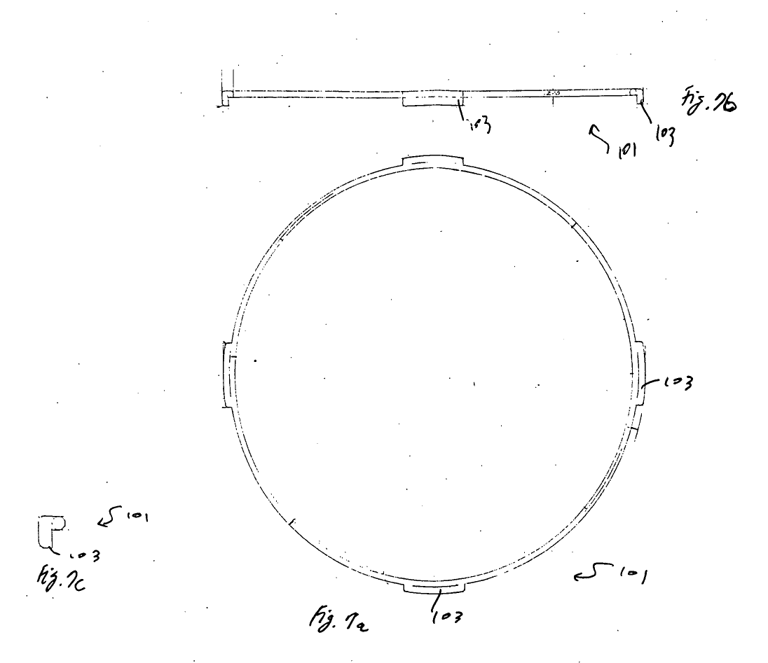

FIG. 7a shows a plan view of an O-ring 101. The O-ring 101 is fitted in an O-ring track 96. The O-ring 101 is especially configured to have four O-ring platforms 103 placed at equal interval from adjacent O-ring platforms 103 as shown. In FIG. 7b and FIG. 7c, the O-ring platforms' profile can be seen.

The cross-sectional view of the inner tire segment 81 and the centering element 90, along with the interior and exterior wheel halves 30a and 20a, can be seen in an assembled state in FIG. 6. In the military tactical run flat tire application, a military tire 95 is used. And, the military tire 95 is seen in its normal inflated state A as well as in a deflated run flat state B. Military vehicle tire beads 97, 98 are positioned against the integral rim sections 23a and 37a of the exterior and interior wheel halves 20a and 30a, respectively, in a normal inflated state of the tire. As can be seen in the figure, the bead lock 99 of the centering element 90 firmly locks the military vehicle tire bead 98 against the integral rim section 37a in a small section defined between the integral rim section 37a and a bead lock stop 111. The bead lock 99 is held securely in place by the bead lock stop 111.

A number of advantages of the military tactical run flat wheel according to the present invention will herein be explained. The first problem stated above under background of invention for the military tactical run flat tire can be solved by employing the wheel system of the present invention. It is accomplished by employing the military vehicle integral centering element 90 as shown above, as well as segmenting the inner tire 80 into four equal 90° sections 81, in FIG. 8. A variation in the shapes and cuts of the sections may be made within the spirit of the present invention. The four inner tire sections 81 are separately inserted into the air chamber of the surface tire without obstructions of specialized equipment or tools prior to the insertion of the remaining two modular wheel halves, 20a and 30a. The modular wheel halves 20a and 30a, when assembled with the inner tire 80 and the centering element 90, are designed to interlock concentrically. During the course of this assembly, the O-ring 101 is also to be inserted on the inner circumference of the inboard modular half 30a. An additional O-ring 28 is also provided in a channel 29 provided in the exterior wheel half 20a. These O-rings 28 and 101 together block and seal substantially all air passage due to the four segmented inner tire sections 81 through the inner tire assembly. When all of the above is located on the military vehicle integral centering element 90, thereby locking and eliminating any lateral movement, the twenty attachment screws 94 are then tightened and torqued to no more than 100 lbs each. In the end, the assembly results in a concentric rigid solid state object. FIG. 10 shows a plan view of the wheel system showing the inner tire segments 85 in place.

One of the advantages of the wheel system designed for the military vehicle use is that the time required to disassemble and re-assemble it when it becomes deflated and disabled is approximately thirty minutes as opposed to about five hours required for an existing conventional method.

In addition, similar to the case of light weight application, the run flat wheel for the military use has the advantage of the tire beads 97 staying in their places when the military vehicle tire 95 is deflated, unlike the conventional tire without the use of the present invention.

In summary, the present invention provides a wheel structure which avoids many of the problems associated with prior art designs.

Various changes and modifications of the present invention may be made in carrying out the present invention without departing from the spirit and scope other of Insofar as these changes and modifications are within the purview of the appended claims, they are to be considered part of the present invention.

What is claimed is:

1. A wheel system having an interior wheel half and an exterior wheel half, for use with a tire, comprising: an integral centering element disposed between the interior wheel half and the exterior wheel half, and centering the two halves, having a inner bead lock for locking a bead of the tire.

2. A wheel system for a tire, having an interior wheel half on an interior side and an exterior wheel half on an exterior side, comprising: an integral centering element for centering the interior wheel half and the exterior wheel half, the integral centering element having: a collar provided in the center of the integral centering element; a disk section having a plane; and a rim section provided on the opposite end of the disk section away from the collar, formed to protrude away from a plane of the disk section and having an interior end and an exterior end, the rim section having a bead lock for locking a bead of the tire on the interior end and a step on the rim section between its connection with the disk section and the exterior end.

3. The wheel system as claimed in claim 2, wherein the step faces a tire mounting well of the wheel.

4. The wheel system as claimed in claim 2, further defining an air sensor aperture for accommodating an air sensor for sensing tire pressure.

5. The wheel system as claimed in claim 2, further defining multiple lightening holes in a circular manner in the rim section.

6. A wheel system having two opposing wheel halves for use with a military vehicle, comprising an integral centering element having a disk-like main body having a collar at an inner section and a flange at the interior section thereof; a first flange connected to the flange; and a second flange also connected to the flange, and multiple inner tire sections disposed inside the tire, a portion of each of which is capable of being disposed between the first and the second flanges.
